(19) United States
(12) Patent Application Publication
(10) Pub. No.: US 2006/0291417 A1
(43) Pub. Date: Dec. 28, 2006

(54) Method for controlling a handover between two network access devices

(76) Inventors: Stefan Aust, Kyoto (JP); Nikolaus Albert Fikouras, Hambergen (DE); Carmelita Gorg, Bremen (DE); Cornel Pampu, Berlin (DE); Daniel Proetel, Bremen (DE)

Correspondence Address: STAAS & HALSEY LLP, SUITE 700, 1201 NEW YORK AVENUE, N.W., WASHINGTON, DC, 20005, US

(21) Appl. No.: 10/573,976

(22) PCT Filed: Sep. 30, 2004
(86) PCT No.: PCT/EP04/52369

§ 371 Date: Mar. 30, 2006

(30) Foreign Application Priority Data
Sep. 30, 2003 (DE) 103455380

(51) Int. Cl. H04Q 7/00; H04J 3/16

(52) U.S. Cl. 370/331; 370/469

(57) ABSTRACT

At least one quality parameter determined in a link layer based on signal transmission to a physical layer mobility-controlling mechanisms of a network layer is used to decide on the transfer in handover between two network access devices. At least one message received by a currently supplying network access device is relayed from the physical layer to the network layer or suppressed according to the at least one quality parameter.

### CROSS REFERENCE TO RELATED APPLICATIONS

This application is based on and hereby claims priority to German Application No. 104 55 28.0 filed on Sep. 30, 2003, the contents of which are hereby incorporated by reference.

### BACKGROUND OF THE INVENTION

1. Field of the Invention

The invention relates to a method for controlling a handover between two network access devices, especially between two radio communication systems. Furthermore, the invention relates to a subscriber terminal capable of performing a method in accordance with the invention.

2. Description of the Related Art

In radio communication systems, for example, the European Mobile Radio System of the second generation GSM (Global System for Mobile Communications), information (for example voice, video information or other data) is transmitted via an interface with the aid of electromagnetic waves. The radio interface refers to a link between a base station and subscriber terminals, whereby the subscriber terminals can be mobile stations or fixed radio stations. The radiation of the electromagnetic waves takes place in this case using carrier frequencies that lie in a frequency band provided for the particular system. Further developments based on the GSM system, known under the terms GPRS or EDGE, for the transmission of higher data rates are designated 2.5^{th} generation. Radio communication system such as UMTS (Universal Mobile Telecommunication System) or other third generation systems are designed for still higher data rates compared with the second generation. Two modes are provided for the third mobile radio generation, with one mode being known as an FDD mode (frequency division duplex) and the other mode as a TDD mode (time division duplex). These modes are used in different frequency bands, whereby each supports a CDMA (Code Division Multiple Access) method.

A combination of the known WLAN (Wireless Local Area Network) infrastructures and the cellular mobile radio systems previously described, enable users of mobile terminals to change active links between these wireless access systems. This is supported by mobility protocols, such as Mobile-IPv4 and Mobile-IPv6, as they are known. The Mobile Internet Protocol (MIP) moreover enables a mobile terminal to retain an allocated IP address when changing to a different wireless system, and therefore to be accessible via this IP address regardless of the system through which it is currently connected. This protocol is explained in detail particularly in C. E. Perkins IP Mobility Support, Request for Comments Proposed Standard) 2002, Internet Engineering Task Force (IETF), October 1996.

The principle approaches to connection relaying between heterogeneous systems of this kind is described in S. Aust, D. Proetel, A. Könsgen, C. Pampu, C. Görg “Design Issues of Mobile-IP Handoffs between General Packet Radio Service (GPRS) Networks and Wireless LAN (WLAN) Systems”, WPMC 2002, Honolulu, Hi. (USA), October 2002. This especially discusses the problem that during a handover between WLAN and cellular mobile systems disadvantageous data losses and connection interruptions can occur due to undefined handovers. Such losses and interruptions can especially be attributed to situations in which the mobile terminal is in a border area of a WLAN coverage and a handover to a cellular system could be carried out. In this case, however, for example due to undefined or insufficiently-defined threshold values during the handover controlled by the Mobile-IP protocol, something called a ping-pong effect can occur, with a connection being repeatedly transferred between the two access systems.

The ping-pong effect is, for example, the result of the fact that so-called mobile agent advertisements, that support a mobile detection of the mobile terminal, can be only sporadically or irregularly received by a mobile terminal in the boundary area of a WLAN coverage due to the deteriorating transmission conditions.

FIG. 1 shows, with reference to FIGS. 1 and 2 and associated descriptions of the aforementioned article of S. Aust et al, an example of a Mobile-IP handover (hand-off) between network A, network B and network C. It is assumed that networks A and C each support a WLAN system and network B a cellular system, for example in accordance with the GPRS standard. A transmission of data takes place in accordance with the system architecture of the Mobile-IP from so-called a correspondent node (CN) as a data source via a so-called home agent (HA) and, provided the mobile terminal (Mobile Node) is not in the coverage area of the home agent, at least via a so-called foreign agent (FA) to the mobile terminal as a data sink, or in the reverse direction. The foreign agents (FA) are, depending on the particular system, each connected to access points that supply hot spots per WLAN, or via other packet data transmission-supporting network components with base station cellular systems.

It is further assumed that in the example in FIG. 1 network A represents a WLAN-based access system and that the mobile terminal is initially located in a hot spot of an access point of this system and receives data via the access point in a active connection. Network B on the other hand is a GPRS-based cellular access system with radio cells being supplied with technical radio resources by a number of base stations. Network C in turn represents a WLAN-based access system.

If the mobile terminal moves in the direction of a boundary of the radio coverage area of network A, interference to the reception of the Mobile-IP advertisements periodically transmitted from the foreign agent (FA) of network A occurs due to the deteriorating transmission properties of the radio interface between the access point of network A and the mobile terminal. If the mobile terminal is in an overlap area of network A and B so that it can also receive signals from a base station of network B, it controls a vertical handover from network A to network B if the handover properties to network B are more favorable than to network A. After a handover has been completed, the mobile terminal henceforth receives the corresponding Mobile-IP advertisements via the foreign agent (FA) of network B. During the handover, the mobile terminal is, however, disadvantageously not in a position to receive data packets from one of the systems participating in the handover, so that losses of data packets and sometimes considerable delays can occur when transmitting data packets.

Particularly in situations in which the mobile terminal is in an overlap area of two networks, the aforementioned ping-pong effect can occur due to the inadequately defined threshold values, with the connection between the two networks being switched backwards and forwards and the mobile terminal receiving Mobile-IP advertisements from each of the two relevant foreign agents (FA). A scenario of this kind can occur both with Mobile-IP-based handovers between WLAN/WLAN systems, called homogenous systems, and between heterogeneous networks, such as a combination of WLAN/GPRS, WLAN/UMTS and GPRS/UMTS.

For a defined handover of a connection between, for example a WLAN and a cellular system, it is, however, necessary to avoid data packet losses or the reception of data packets in an incorrect sequence due to successive or undefined handovers, because this, particularly with multimedia applications, can cause faulty presentation, for example, of audio or video data. An example of the loss of data packets due to undefined handovers is shown in FIG. 2.

FIG. 2 shows measurements of Mobile-IP-based handovers between a WLAN and a GPRS system. At the start of the measurements, the mobile terminal moving at a speed of between 0.2 and 0.5 m/s is connected to the WLAN infrastructure, that can be seen by a high data throughput due to the maximum data rate of 11 Mbit/s possible in a WLAN system (solid line). After approximately 25 seconds the mobile terminal moves slowly out of the coverage area of the WLAN system, which means that the signal strength of the signals received from the WLAN system become weaker. Because of the weakening signal strength, advertisements of the WLAN system are received only sporadically by the mobile terminal, which in turn leads to multiple handovers between the WLAN and GPRS system. The multiple handovers in this case lead to very high data packet losses (shown by a star in each case), that can be observed in a time period of between 25 seconds and 75 seconds. After approximately 75 seconds, the mobile terminal has completely left the WLAN coverage. A prolonged handover to the GPRS system, shown by the comparably low data rate, then takes place.

Furthermore, a higher data packet loss after approximately 15 seconds on the return of the mobile terminal to the WLAN coverage can be seen in FIG. 2. In this case also, losses of received data packets, that in this case can be seen up to approximately 125 seconds, occur due to undefined Mobile-IP handovers. Within the link to the GPRS system and with an adequate signal strength within the WLAN coverage, there are on the other hand none, or only relatively small, losses of data packets due, for example to scatter or reflections.

The problem of undefined handovers has already been recognized and described in the “Design of Vertical Mobile-IP handoff requirements” chapter of the aforementioned article by S. Aust et al. As an initial solution, this proposes defining a hysterese with two threshold values, with a lower threshold value being defined for an inadequate signal strength for the transmission from an access point, and an undershoot of this lower threshold value triggering a vertical handover to a GPRS network, with the mobile terminal suppressing advertisements of the WLAN system during the handover. An upper threshold value on the other hand signifies an adequate signal strength, with the mobile terminal triggering a handover from the GPRS network to the WLAN system if it is overshot.

Despite the described definition of a hysteresis for controlling a handover between two systems and the associated avoidance of multiple handovers, the handover demands a great deal of time, in which disadvantageous losses of data packets can occur.

### SUMMARY OF THE INVENTION

An object of the invention is therefore to provide a method and a subscriber terminal that accelerates a Mobile-IP-based handover between two systems.

According to an aspect of the invention, a method for controlling a handover between two network access devices is proposed, whereby the handover is carried out according to at least one quality parameter determined in a link layer on the basis of signal transmissions on a physical layer, with mobility-controlling mechanisms of a network layer being used to decide on the handover. The method in accordance with the invention is characterized in that at least one message received by a currently supplying network access device is relayed from the physical layer to the network layer, or suppressed, according to at least one determined quality parameter.

As described in the introduction, a mobile terminal performs a handover in the context of a Mobile-IP-based transmission, if interference occurs during the reception of messages, called advertisements, of the current supplying system, for example due to deteriorating transmission conditions at the radio interface. A feature in accordance with the invention advantageously enables an acceleration of the handover by a conditional suppression of the relaying of messages received on the physical layer to the higher-level network layer. The suppression of the relaying, moreover, takes place based on measurements of the physical layer with regard to a transmission quality of the current link. Because the network layer controlling the mobility of the mobile terminal receives no further aforementioned messages due to suppression, it immediately controls a handover to a second network access device. Advantageously, a possible loss of reception of data packets is reduced due to the accelerated decision and performance of a handover.

In accordance with an alternative form of embodiment of the invention, the insertion of at least one message for relaying to the network layer is performed again depending on at least one determined quality parameter. This configuration has the advantage that an initialization of a handover, for example due to only short-term interference, can be avoided and the frequency of handovers, accompanied by reduced loss of data during these handovers, can be reduced.

In accordance with a first development of the invention, the decision is made regarding the relaying or insertion of at least one message in an intermediate layer arranged between the link layer and network layer. The definition of an intermediate layer of this kind has the advantage that existing standards, for example the Mobile-IP standard described in the introduction does not have to be changed and thus a simple implementation of the method in accordance with the invention is enabled.

According to a further form of embodiment of the invention, the decision is made on the basis of a comparison of at least one determined quality parameter with a least one specified threshold value. A comparison of this kind has the advantage that exact conditions can be defined, the fulfillment of which is a precondition for the suppression or insertion of messages.

Particularly advantageously in accordance with a development of the invention based on the preceding form of embodiment at least one threshold value is individually defined for the network access devices. In this case, the radio transmission standard supported by the device can be particularly advantageously considered, because this can lead to different quality parameters due to a use, for example of different frequency bands or codings.

According to second further developments, additional conditions are considered when controlling the handover. Accordingly, to avoid increased loss of data, it can be useful to wait a specific time interval after a handover before a new handover is carried out. As an alternative or addition, this can be designed using received messages with a handover not being enabled until a certain number of received messages has been exceeded. These additional parameters can advantageously be implemented in the functionality of the intermediate layer.

A mobile terminal in accordance with the invention is capable of performing the described method.

### BRIEF DESCRIPTION OF THE DRAWINGS

These and other objects and advantages of the present invention will become more apparent and more readily appreciated from the following description of exemplary embodiments, taken in conjunction with the accompanying drawings of which:

FIG. 1 is a block diagram an exemplary Mobile-IP-based handover between different access networks.

FIG. 2 is a graph of examples of measurements of data packet losses during handovers between WLAN and GPRS systems.

FIG. 3 is a layer model with an exemplary integration of POLIMAND

FIG. 4 is a functional block diagram illustrating control of the suppression of messages using POLIMAND.

FIG. 5 is a graph of examples of measurements from FIG. 2 using POLIMAND.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

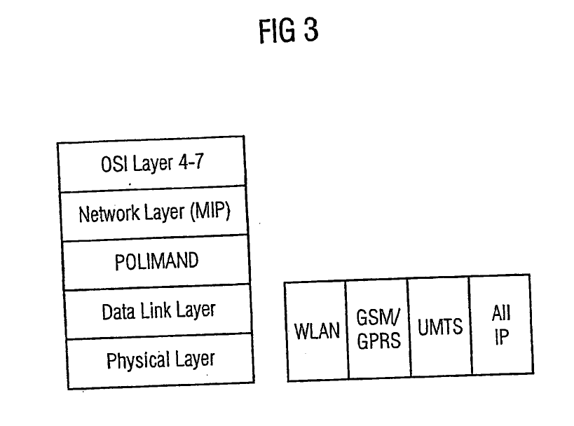

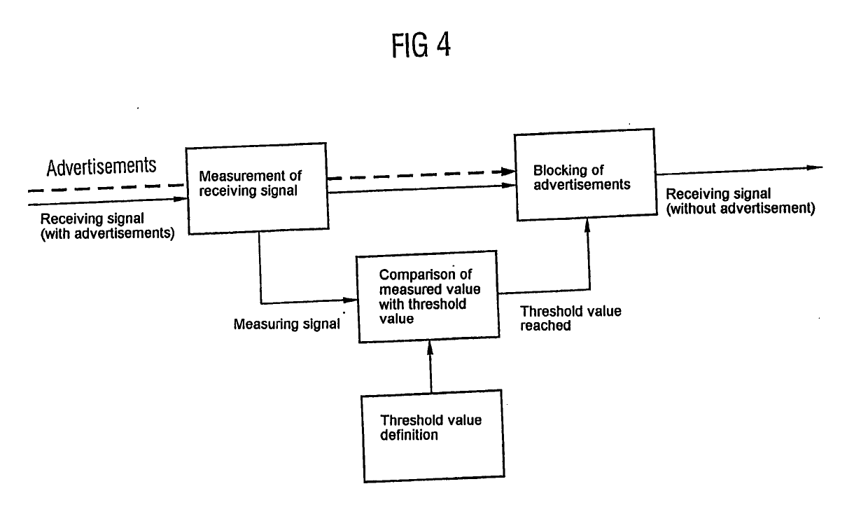

A realization of a method in accordance with the invention in a mobile subscriber terminal is described in the following with reference to FIGS. 3 and 4.

FIG. 3 shows an example of a known OSI layer model, such as is used in telecommunication engineering for defining different layers. At the lowest layer, called the physical layer, or also layer 1, a transmission of signals takes place via a transmission media, the radio interface is used in the following as the example. The structure of the physical layer is defined relative to the particular standard used, for example in accordance with the named standards WLAN or 802.11, GSM/GPRS, UMTS etc.

Control of the connection takes place at a higher layer, called the data link layer. This control includes an analysis or a determination of current transmission properties or quality parameters of the physical layer, in order to match the connection parameters with the actual transmission properties.

Transmission properties can, for example, be determined in the form of signal-to-noise ratio (SNR), the signal strength, noise level, a bandwidth, latency or a bit or frame error rate or other QoS (Quality of Service) parameters of the received signal.

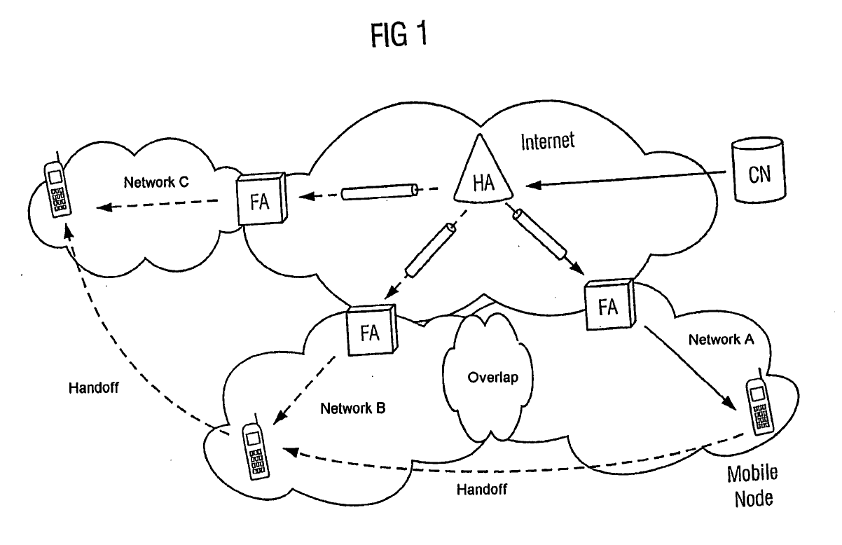

Based on the example in FIG. 1, described in the introduction, with a WLAN system, the known parameters link quality, quality level and/or noise level can be used to assess the current transmission parameters, with the link quality parameter representing a combination of the other two parameters, and thus containing information on the actual signal strength and noise level.

In particular with regard to the application of the method in accordance with the invention in different systems, the use of standard parameters is advantageous. This can also be in the form of a combination of several of the aforementioned parameters for definition of an optimum decision criterion for controlling a handover. This particularly applies to future Generic-Link-Layer-Standards (GLL), as they are called, in which different access systems use standard network parameters.

To enable connection relaying between access networks, that support different transmission standards, it is appropriate to select quality parameters that can be determined in the supporting networks, for example networks based on the given standards WLAN, GSM/GPRS, UMTS or pure IP-based Al1 IP. In the example described in the following, a signal-to-noise ratio is used as such a quality parameter.

Above the data link layer is an intermediate layer according to the invention, that in the following is called a POLIMAND (Policy based Mobile IP Handoff Decision). This intermediate layer decides, as explained in more detail in the following, depending on determined quality parameters on the link layer corresponding to the preceding description, whether messages received on the physical layer are to be relayed to a network layer or not.

On the network layer, also called layer 3, control of the handover again takes place in accordance with known mechanisms on the basis of the Mobile Internet Protocol MIP. As an alternative to the named Mobile-IP, further embodiments of the standard, for example the Hierarchical Mobile-IP (HMIP) or the Fast Mobile-IP (FHM IP) can be used in a similar manner. There are further layers above the network layer, corresponding to the OSI layer model, but the content of these is not considered.

FIG. 4 shows an example of a flow diagram of the functioning of the POLIMAND intermediate layer in conjunction with the described layers located above and below it during the implementation in a subscriber terminal in the situation illustrated in FIG. 1.

The subscriber terminal receives signals of a WLAN access point of network A of FIG. 1 sent via the interface, with the received signal also containing messages called mobility agent advertisements of the Mobile-IP. The signal flow of the message advertisements is shown by a dotted line. A measuring signal as an input variable for a subsequent comparison with a threshold value is determined from a measurement of the received signal. As previously described, the measuring signal, for example, as a signal-to-noise ratio represents a quality parameter that indicates the current signal quality. If the measured signal quality is worse, a handover from the current covering WLAN system, for example to a GPRS system, is necessary. If the received signal on the other hand has sufficient signal quality, no handover is initially necessary.

The determined quality parameter as a measuring signal is compared with a threshold value. The threshold value is moreover, for example, defined as a function of the particular transmission standard, to take account of the individual differences in the various transmission methods. The threshold values can, for example, be defined by the current covering system and transmitted to the subscriber terminal after or during a handover and saved in the subscriber terminal.

In the illustrated case, the quality parameters are compared with a defined threshold value that represents a low value of a signal-to-noise ratio adequate for a connection. If this threshold value is reached or undershot, a handover to a system with satisfactory transmission conditions is carried out in accordance with the preceding description.

In addition to a lower threshold value for a handover to another system, for example to the GPRS system of network B in FIG. 1, an upper threshold value is also defined which if reached or overshot causes a handover from the other system back to the original system to take place. A hysterese that avoids the ping-pong effect previously described is defined by these two threshold values and, for example also ensures that a connection persists for the longest possible time via the WLAN system, because this makes available a distinctly higher transmission capacity than the GPRS system.

If the specified quality parameter reaches or undershoots the defined threshold value when compared, the handover of the received message or message advertisements to the network layer or Mobile-IP MIP is suppressed or blocked. Accordingly, only the further reception signals without messages are handed over to the higher layer (the dotted line ends here). This suppression or blocking can, for example be achieved using a system script. A corresponding procedure would be implemented if the upper threshold value were exceeded.

The suppression or blocking of the message advertisements at an earlier time point suggests to the Mobile-IP mechanisms responsible for the mobility and handover that the transmission properties have deteriorated and therefore a handover to another system is necessary. The objective of a defined and accelerated handover is achieved by this, which advantageously minimizes loss of data packets due to handovers.

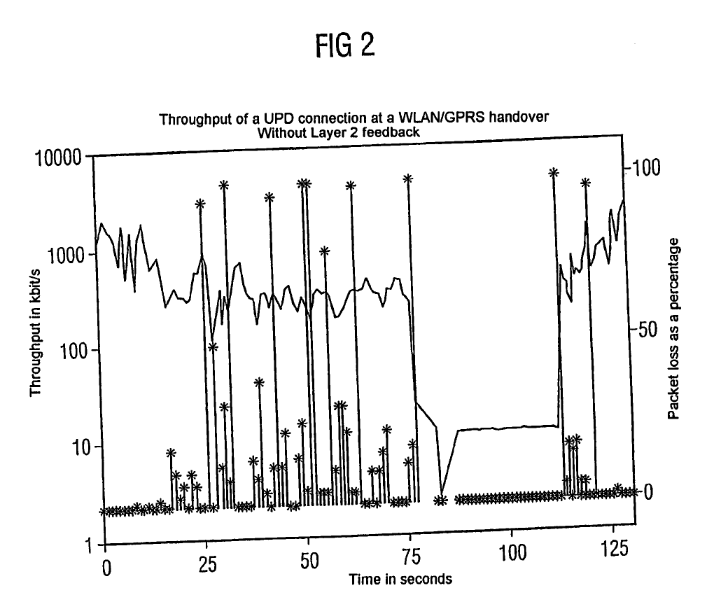

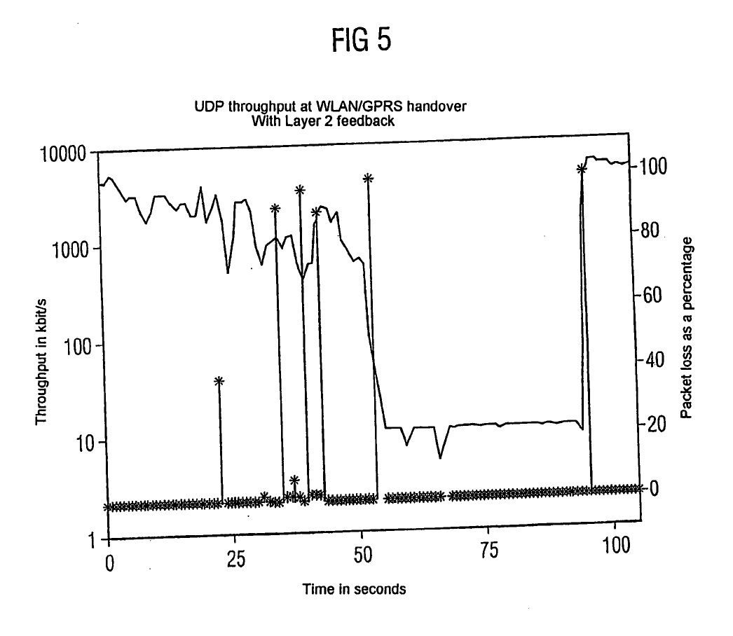

FIG. 5 shows the example from FIG. 2 again, but this time using the suppression of messages as described, known as layer 2 feedback. It can be clearly seen from the comparison that a clear reduction of the packet data loss (indicated by asterisks) is achieved due to the early Mobile-IP based handover. This handover to the GPRS system takes place earlier compared with that in the example in FIG. 2, because on the basis of the determined signal-to-noise ratio a predetermined threshold value is reached that correspondingly activates the POLIMAND intermediate layer to suppress the relaying of messages and thus provokes a Mobile-IP based handover.

As an addition or alternative, it can be advantageous if messages are inserted by the POLIMAND intermediate layer when relaying reception signals. This can be used, for example if no messages are received by the mobile terminal, due for example to short-term interference to the transmission via the radio interface, but certain quality parameters still indicate that there is an adequate transmission quality to maintain a link. Because the omission of a message mechanism for controlling a handover could be activated in the Mobile-IP, the current link, that compared to a system used for the transfer supports a far higher transmission rate, is advantageously maintained by inserting the messages.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-9. (canceled)

10. A method for controlling a handover between two network devices, comprising:
determining at least one quality parameter in a link layer based on signal transmissions on a physical layer, with a mobility-controlling mechanism of a network layer; and
carrying out the handover as a function of the at least one quality parameter, including, as a function of the at least one quality parameter, either
relaying, in preparation for the handover, at least one message received by a currently supplying network access device from the physical layer to the network layer, or
suppressing transmission of the at least one message.

11. A method in accordance with claim 10, further comprising making a decision regarding said relaying in an intermediate layer arranged between the link layer and the mobility-controlling network layer.

12. A method in accordance with claim 11, wherein said making of the decision is in accordance with a comparison of the at least one quality parameter with at least one specified threshold value.

13. A method in accordance with claim 12, wherein the at least one threshold value is defined specific to a network access device.

14. A method in accordance with claim 13, wherein the handover is carried out between two network devices supporting two different standards on the physical layer.

15. A method in accordance with claim 14, further comprising not carrying out the handover until a specified time interval has elapsed after completion of a preceding handover.

16. A method in accordance with claim 15, further comprising not carrying out the handover until after a determined number of received advertisements has been exceeded.

17. A method for handover between two network devices, comprising:
carrying out the handover as a function of at least one quality parameter determined in a link layer based on signal transmissions on a physical layer, with a mobility-controlling mechanism of a network layer being used to decide on the handover; and
inserting, in preparation for the handover, an advertisement in reception signals relayed to the network layer according to the at least one quality parameter.

18. A method in accordance with claim 17, further comprising making a decision regarding said insertion of the at least one advertisement in an intermediate layer arranged between the link layer and the mobility-controlling network layer.

19. A method in accordance with claim 18, wherein said making of the decision is in accordance with a comparison of the at least one quality parameter with at least one specified threshold value.

20. A method in accordance with claim 19, wherein the at least one threshold value is defined specific to a network access device.

21. A method in accordance with claim 20, wherein the handover is carried out between two network devices supporting two different standards on the physical layer.

22. A method in accordance with claim 21, further comprising not carrying out the handover until a specified time interval has elapsed after completion of a preceding handover.

23. A method in accordance with claim 22, further comprising not carrying out the handover until after a determined number of received advertisements has been exceeded.

24. A subscriber terminal communicating with first and second network access devices, comprising:
means for receiving signals of a connection transmitted on a physical layer from the first network access device;
means for determining at least one quality parameter based on received signals; and
means for controlling relaying of an advertisement, received from the first network access device, to a mobility-controlling mechanism of a network layer, according to the at least one quality parameter, with the mobility-controlling mechanism being designed to control a handover of a link to the second network access device according to received advertisements.
